(19) United States
(12) Patent Application Publication
(10) Pub. No.: US 2026/0356213 A1
(43) Pub. Date: Nov. 12, 2026

(54) Transport Facility

(71) Applicant: Daifuku Co., Ltd., Osaka-shi (JP)

(72) Inventor: Yuki Ihira, Komaki-shi (JP)

(21) Appl. No.: 19/668,918

(22) Filed: May 6, 2026

(30) Foreign Application Priority Data
May 7, 2025 (JP) 2025-077236

(51) Int. Cl. B60L 15/38; B60L 50/53; B60L 53/63; B60L 58/12

(52) U.S. Cl. CPC B60L 15/38; B60L 53/63; B60L 58/12; B60L 50/53; B60L 2200/26

(57) ABSTRACT

A transport facility includes a control system. A first transport vehicle travels using electric power received by a first power reception device. A second transport vehicle travels using electric power stored in a power storage device. In a case where there is an incoming transport vehicle that is about to newly enter a power feeding area, the control system performs a determination process of determining whether or not total electric power as a total amount of supply power for at least one existing transport vehicle and supply power for the incoming transport vehicle exceeds an upper power limit. In response to determining that the total electric power exceeds the upper power limit, the control system performs an entry restriction process of restricting the incoming transport vehicle from entering the power feeding area.

### CROSS-REFERENCE TO RELATED APPLICATION

This application claims priority to Japanese Patent Application No. 2025-077236 filed May 7, 2025, the disclosure of which is hereby incorporated by reference in its entirety.

### BACKGROUND OF THE INVENTION

### 1. Field of the Invention

The present invention relates to a transport facility including a plurality of transport vehicles configured to travel along a travel path, and a power feeding apparatus including a power feeding member provided along the travel path.

### 2. Description of Related Art

Japanese Unexamined Patent Application Publication No. 2024-057317 discloses an example of an article transport facility as described above. The article transport facility described in Japanese Unexamined Patent Application Publication No. 2024-057317 includes an article transport vehicle (30) configured to travel on a travel path (10) to transport an article. The article transport vehicle (30) includes a drive motor (14) driven by electric power from a feeder cable (3) provided in the travel path (10) to cause the article transport vehicle (30) to travel on the travel path (10).

In the transport facility described in Japanese Unexamined Patent Application Publication No. 2024-057317, it is necessary to control the total of supply power for transport vehicles not to exceed the upper limit of supply power in a power feeding area defined on the travel path. Accordingly, in a case where a large number of transport vehicles have been already present in the power feeding area, it may be necessary to restrict entry of a new transport vehicle into the power feeding area. However, in a case where the entry of a new transport vehicle into the power feeding area is often restricted, such a problem occurs that it is difficult to improve the transport efficiency of the transport facility.

### SUMMARY OF THE INVENTION

In view of the foregoing, it is desired to achieve a transport facility whose transport efficiency is easily improved.

A transport facility according to this disclosure includes: a plurality of transport vehicles configured to travel along a travel path; a power feeding apparatus including a power feeding member provided along the travel path; and a control system configured to control the plurality of transport vehicles. The plurality of transport vehicles includes a first transport vehicle and a second transport vehicle. The first transport vehicle includes a first power reception device configured to receive electric power from the power feeding member to cause the first transport vehicle to travel using electric power received by the first power reception device. The second transport vehicle includes a power storage device and is configured to travel using electric power stored in the power storage device. The travel path provided with the power feeding member includes a power feeding area. The control system is configured as follows: in a case where there is an incoming transport vehicle that is about to newly enter the power feeding area, the control system performs a determination process of determining whether or not total electric power, which is a total amount of supply power for at least one existing transport vehicle already present in the power feeding area and supply power for the incoming transport vehicle, exceeds an upper power limit, which is an upper limit of supply power from the power feeding apparatus and is determined for the power feeding area; in response to determining that the total electric power exceeds the upper power limit, the control system performs an entry restriction process of restricting the incoming transport vehicle from entering the power feeding area; and in the determination process, the control system determines the supply power for the at least one existing transport vehicle based on whether the at least one existing transport vehicle is the first transport vehicle or the second transport vehicle, and determines the supply power for the incoming transport vehicle based on whether the incoming transport vehicle is the first transport vehicle or the second transport vehicle.

With this configuration, it is possible to prevent the supply power from the power feeding apparatus to the transport vehicles present in the power feeding area from exceeding the upper power limit. Accordingly, it is possible to appropriately supply electric power to all the transport vehicles present in the power feeding area and to reduce the possibility that a malfunction may occur due to an overload of the power feeding apparatus. In this case, the supply power for each of the incoming transport vehicle and the existing transport vehicle is determined based on whether the each of the incoming transport vehicle and the existing transport vehicle is the first transport vehicle or the second transport vehicle. Accordingly, supply power necessary for the second transport vehicle that travels using electric power stored in the power storage device can be determined to be smaller than the supply power for the first transport vehicle, for example. Accordingly, in comparison with a case where the entry restriction process is performed just based on the number of transport vehicles or the like, it is possible to reduce the frequency of performing the entry restriction process. This makes it possible to easily increase the number of transport vehicles that can pass through the power feeding area and eventually to easily increase the transport efficiency in the transport facility.

Further features and advantages of the technology according to this disclosure will become clearer by the following illustrative and nonlimiting description of embodiments to be described with reference to the drawings.

### BRIEF DESCRIPTION OF THE DRAWINGS

FIG. 1 is a top view of a transport facility according to an embodiment;

FIG. 2 is a view to describe a first transport vehicle and a second transport vehicle in FIG. 1;

FIG. 3 is a view illustrating a power feeding apparatus of the transport facility in FIG. 1;

FIG. 4 is a view illustrating a power feeding area defined on a travel path in FIG. 1; and

FIG. 5 is a control block diagram of the transport facility in FIG. 1.

### DESCRIPTION OF THE INVENTION

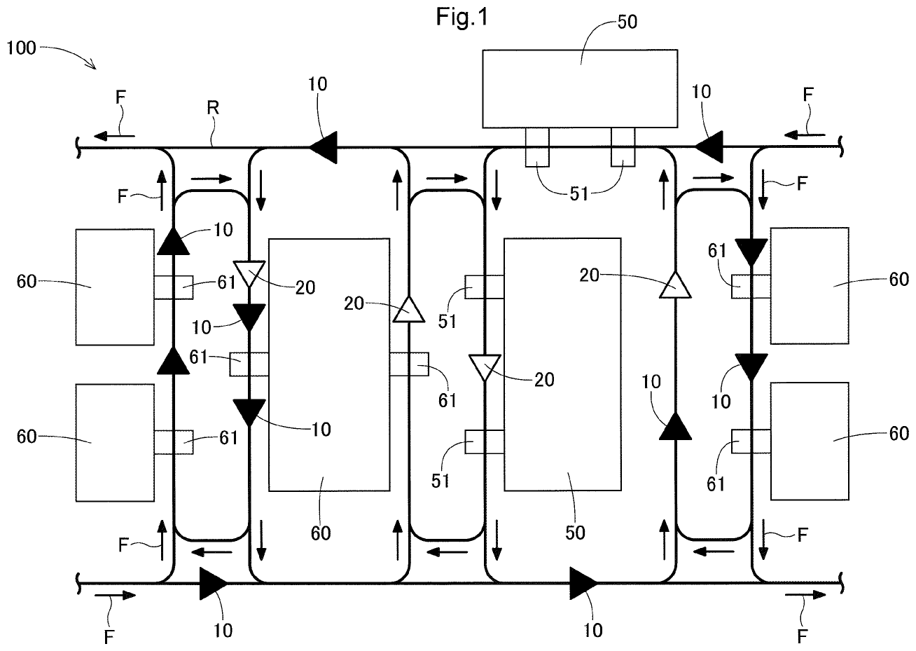

An embodiment of a transport facility 100 will be described below with reference to the drawings. FIG. 1 is a view schematically illustrating an example of the top surface of the transport facility 100. The transport facility 100 includes a plurality of transport vehicles configured to travel along a travel path R. The plurality of transport vehicles include a first transport vehicle 10 and a second transport vehicle 20. In the present embodiment, the plurality of transport vehicles include a plurality of first transport vehicles 10 and a plurality of second transport vehicles 20. In the present embodiment, the number of second transport vehicles 20 is smaller than the number of first transport vehicles 10.

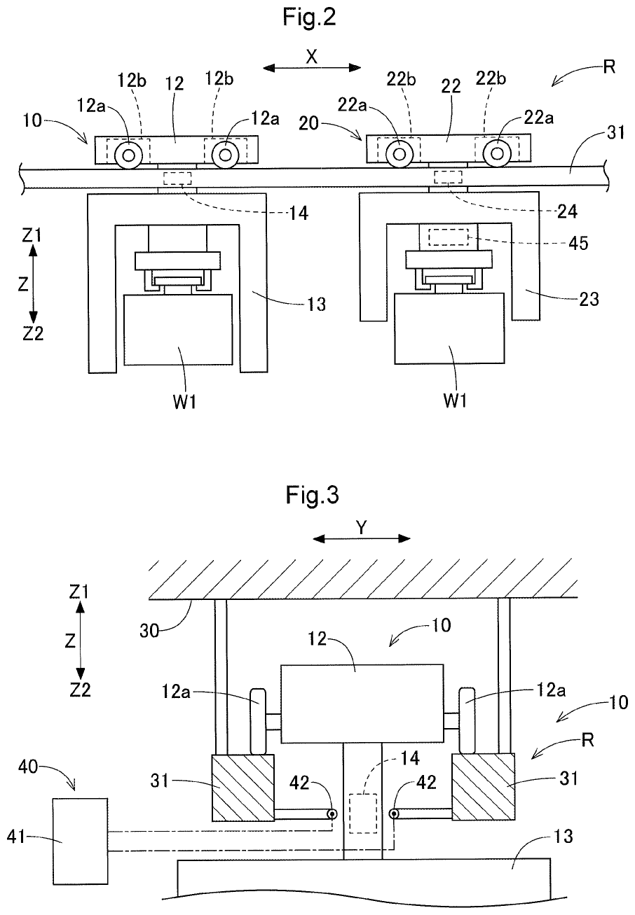

FIG. 2 is a schematic view illustrating an example of respective lateral surfaces of the first transport vehicle 10 and the second transport vehicle 20. FIG. 3 is a schematic view illustrating an example of a power feeding apparatus 40. In the present embodiment, the first transport vehicle 10 and the second transport vehicle 20 are overhead transport vehicles configured to travel on the travel path R formed along a ceiling 30. In the present embodiment, the first transport vehicle 10 and the second transport vehicle 20 are unmanned transport vehicles. Note that the travel path R may be formed on a floor surface or the like instead of the ceiling 30. The travel path R may be provided without the use of rails, and the travel path R may be provided to connect a plurality of detection objects (two-dimensional codes, wireless tags, or the like) provided on the floor surface or the like, for example. In the present embodiment, the travel path R is formed by rails 31.

The transport facility 100 includes the power feeding apparatus 40. The power feeding apparatus 40 includes a power feeding member 42 provided along the travel path R. The power feeding apparatus 40 includes a power source unit 41 configured to supply electric power to the power feeding member 42. Electric power may be supplied from the power feeding member 42 to a transport vehicle via conductive power transfer or wireless power transfer. Examples of the power feeding member 42 include an induction line, a power feeding rail, and the like. In the present embodiment, the power feeding member 42 is an induction line and wirelessly supplies electric power to the transport vehicle.

Here, a front-rear direction X is defined as a direction along the travel path R. A right-left direction Y is defined as a direction perpendicular to the front-rear direction X and an up-down direction Z. The travel path R may be configured as a one-way path or may allow bidirectional travel in the front-rear direction X. In the present embodiment, the travel path R is a one-way path. In the present embodiment, the travel path R is formed by a pair of rails 31 disposed at an interval in the right-left direction Y. The rails 31 are hung from the ceiling 30. In the present embodiment, a pair of power feeding members 42 is disposed along a pair of rails 31 at an interval in the right-left direction Y.

As illustrated in FIG. 1, a forward direction F is defined at each portion of the travel path R. The first transport vehicle 10 and the second transport vehicle 20 travel in the forward direction F at each portion of the travel path R. The travel path R illustrated in FIG. 1 includes a junction at which a plurality of paths merges into one path, and a branch at which one path is divided into a plurality of paths.

As illustrated in FIG. 2, the first transport vehicle 10 is driven by electric power and travels along the travel path R. The first transport vehicle 10 includes a first travel unit 12 driven by electric power to travel along the travel path R. The first travel unit 12 includes first travel wheels 12a configured to roll over the rails 31. The first travel wheel 12a is rotated by a first electric machine 12b provided in the first travel unit 12.

The second transport vehicle 20 is driven by electric power and travels along the travel path R. The second transport vehicle 20 includes a second travel unit 22 driven by electric power to travel along the travel path R. The second travel unit 22 includes second travel wheels 22a configured to roll over the rails 31. The second travel wheel 22a is rotated by a second electric machine 22b provided in the second travel unit 22.

The first transport vehicle 10 includes a first transfer unit 13 driven by electric power to transfer a transport article W1. The first transfer unit 13 is coupled to the first travel unit 12. The first travel unit 12 is located on an upper side Z1 relative to the first transfer unit 13. The first transfer unit 13 receives the transport article W1 from a transport source and delivers the transport article W1 to a transport destination. Examples of the first transfer unit 13 include a lifting and lowering device, a conveyor, and the like. Examples of the transport article W1 include a product, a vehicle component, an electronic component, a food product, a container, and the like.

A transport article W1 transported by the first transport vehicle 10 and a transport article W1 transported by the second transport vehicle 20 may be different in type (for example, weight, dimension, importance, and the like). For example, the transport article W1 transported by the first transport vehicle 10 may be heavier than the transport article W1 transported by the second transport vehicle 20, may have a larger dimension in the front-rear direction X than the transport article W1 transported by the second transport vehicle 20, may have a larger dimension in the right-left direction Y than the transport article W1 transported by the second transport vehicle 20, or may have a larger dimension in the up-down direction Z than the transport article W1 transported by the second transport vehicle 20.

The second transport vehicle 20 includes a second transfer unit 23 driven by electric power to transfer the transport article W1. The second transfer unit 23 is coupled to the second travel unit 22. The second travel unit 22 is located on the upper side Z1 relative to the second transfer unit 23. The second transfer unit 23 receives the transport article W1 from a transport source and delivers the transport article W1 to a transport destination. Examples of the second transfer unit 23 include a lifting and lowering device, a conveyor, and the like.

As illustrated in FIG. 3, the first transport vehicle 10 includes a first power reception device 14 configured to receive electric power from the power feeding members 42. The first transport vehicle 10 travels using electric power received by the first power reception device 14. In the present embodiment, the first power reception device 14 supplies electric power to the first electric machine 12b. In the present embodiment, the first power reception device 14 is provided in a coupler between the first travel unit 12 and the first transfer unit 13. In the present embodiment, the first power reception device 14 wirelessly receives electric power from the pair of power feeding members 42 while the first power reception device 14 is disposed between the pair of power feeding members 42.

The second transport vehicle 20 includes a second power reception device 24 configured to receive electric power from the power feeding members 42. In the present embodiment, the second power reception device 24 has the same structure as the first power reception device 14 illustrated in FIG. 3. The second transport vehicle 20 travels using electric power received by the second power reception device 24. In the present embodiment, the second power reception device 24 supplies electric power to the second electric machine 22b. In the present embodiment, the second power reception device 24 is provided in a coupler between the second travel unit 22 and the second transfer unit 23. In the present embodiment, the second power reception device 24 wirelessly receives electric power from the pair of power feeding members 42 while the second power reception device 24 is disposed between the pair of power feeding members 42.

The second transport vehicle 20 includes a power storage device 45. The second transport vehicle 20 travels using electric power stored in the power storage device 45. The second transport vehicle 20 performs at least one of charging of the power storage device 45 and traveling using electric power received by the second power reception device 24.

The power storage device 45 is a power storage device having a capacity sufficient to store electric power for normally traveling on the travel path R. The power storage device 45 is configured to be chargeable and dischargeable. The power storage device 45 may be, for example, a battery, a capacitor, or a combination of a battery and a capacitor. The power storage device 45 includes a power storage amount sensor configured to detect a power storage amount. The power storage amount sensor includes either of or both a voltage sensor and a current sensor, for example.

In the present embodiment, the first transport vehicle 10 does not include the power storage device 45 for traveling. Here, that “the power storage device 45 for traveling is not provided” means that the power storage device 45 having a capacity sufficient to store electric power for normally traveling on the travel path R is not provided. Note that, for example, the first transport vehicle 10 may include a power storage device configured to cause the first transport vehicle 10 to travel only a short distance in an emergency when the first transport vehicle 10 cannot receive electric power from the power feeding apparatus 40 due to a malfunction or the like.

Note that the first transport vehicle 10 may include a power storage device 45 for traveling with a smaller capacity than the power storage device 45 for traveling that is provided for the second transport vehicle 20. Note that “a smaller capacity” as used herein means that the total capacity of all the power storage devices 45 for traveling that are provided for the first transport vehicle 10 is smaller than the total capacity of all the power storage devices 45 for traveling that are provided for the second transport vehicle 20. The second transport vehicle 20 may be a concept including several types of transport vehicles including respective power storage devices 45 having different capacities, for example. The first transport vehicle 10 may be a concept including several types of transport vehicles.

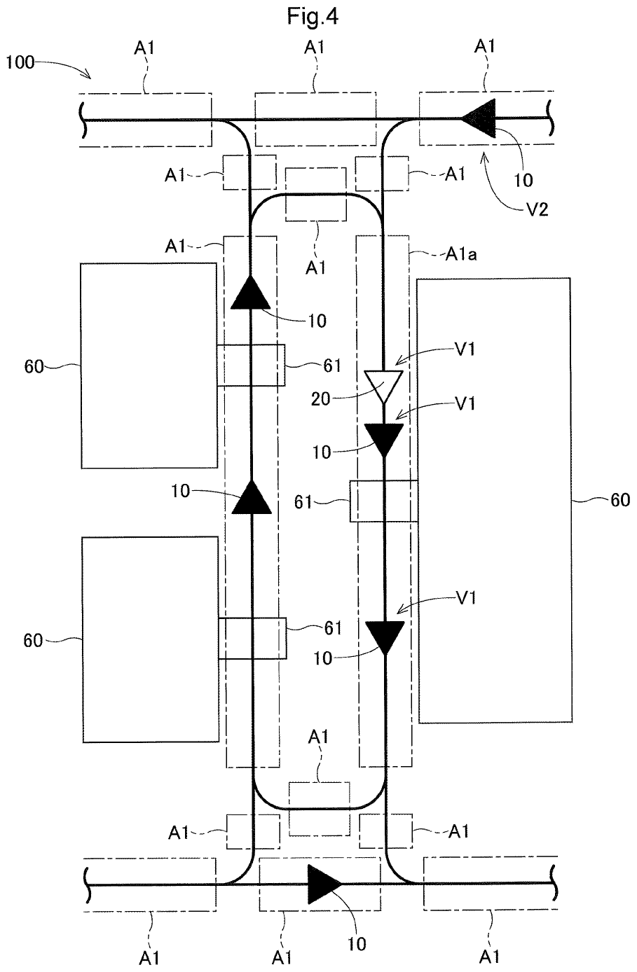

FIG. 4 is a schematic view illustrating examples of a power feeding area A1 defined on the travel path R. The power feeding area A1 is defined on the travel path R provided with the power feeding members 42. In the present embodiment, a plurality of power feeding areas A1 is defined on the travel path R. The power feeding member 42 provided in each of the plurality of power feeding areas A1 is configured to independently supply electric power. In the present embodiment, a power feeding area A1 in which two or more transport vehicles can be present is defined on the travel path R. In the present embodiment, a power feeding area A1 in which three or more transport vehicles can be present is defined on the travel path R.

The transport facility 100 includes a storage apparatus 50 configured to store the transport article W1. In the present embodiment, the storage apparatus 50 includes a loading-unloading section 51. The transport facility 100 includes a processing apparatus 60 configured to perform processing on the transport article W1. Examples of the processing on the transport article W1 include machining, surface treatment, cleaning, sorting, and the like. In the present embodiment, the processing apparatus 60 includes a loading-unloading section 61. Examples of the loading-unloading section 51 and the loading-unloading section 61 include a storage rack, a conveyor, a lifting and lowering device, and the like.

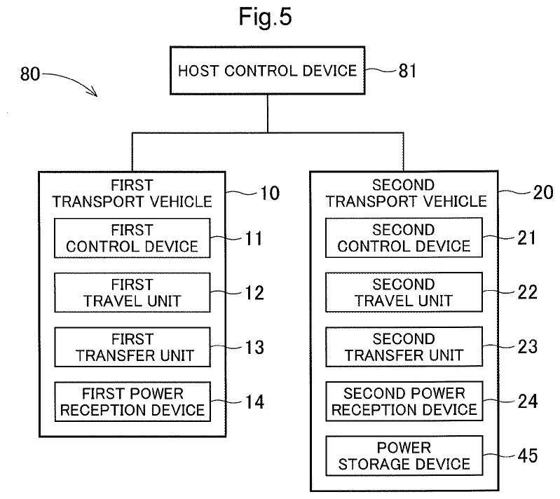

FIG. 5 is a block diagram illustrating an example of a control of the transport facility 100. The transport facility 100 includes a control system 80 configured to control a plurality of transport vehicles. The control system 80 includes a control device including an arithmetic processing unit such as a CPU (Central Processing Unit), and a main storage device such as a RAM (Random Access Memory) or a ROM (Read Only Memory) to which the arithmetic processing unit can refer. Each function of the control device is implemented in collaboration of hardware included in the control device and a program executed on hardware such as the arithmetic processing unit. In the present embodiment, the control device (more specifically, the arithmetic processing unit included in the control device) functions as a “computer.”

In the present embodiment, the control system 80 is constituted by a first control device 11 provided for the first transport vehicle 10, a second control device 21 provided for the second transport vehicle 20, and a host control device 81 communicable with the first control device 11 and the second control device 21. The host control device 81 communicates with the first control device 11 or the second control device 21 using radio waves, light, or the like.

The control system 80 keeps track of the current position of each of the plurality of first transport vehicles 10 and the plurality of second transport vehicles 20. In the present embodiment, the first transport vehicle 10 is configured to recognize its current position, and the second transport vehicle 20 is configured to recognize its current position. The host control device 81 acquires information on the current position of the first transport vehicle 10 from the first transport vehicle 10 and acquires information on the current position of the second transport vehicle 20 from the second transport vehicle 20.

The control system 80 determines a transport path K for each transport vehicle. In the present embodiment, the control system 80 determines a transport path K for a transport vehicle that does not transport a transport article W1, by designating a transport source and a transport destination for the transport article W1. Examples of the “transport source” include the loading-unloading section 51 of the storage apparatus 50, the loading-unloading section 61 of the processing apparatus 60, and the like. Examples of the “transport destination” include the loading-unloading section 51 of the storage apparatus 50, the loading-unloading section 61 of the processing apparatus 60, and the like.

An existing transport vehicle V1 is defined as a transport vehicle already present in the power feeding area A1. An incoming transport vehicle V2 is defined as a transport vehicle that is about to newly enter the power feeding area A1. In FIG. 4, one of the power feeding areas A1 is referred to as a target power feeding area A1a, a reference sign V1 is assigned only to existing transport vehicles in the target power feeding area A1a, and a reference sign V2 is assigned only to an incoming transport vehicle that is about to enter the target power feeding area A1a.

The control system 80 acquires information on respective current positions and respective travel directions of the first transport vehicle 10 and the second transport vehicle 20 and determines an incoming transport vehicle V2 as a transport vehicle that is about to newly enter the power feeding area A1 from positional information and course information. Examples of the information on the travel direction include the transport path K (described later), detection information from a transport-vehicle detection device disposed on the upstream side from the power feeding area A1, and the like.

An upper power limit Nmax (W) is defined as the upper limit of supply power from the power feeding apparatus 40, the upper limit being determined for the power feeding area A1. In the present embodiment, the upper power limit Nmax is determined based on rated supply power of the power feeding apparatus 40.

When there is an incoming transport vehicle V2 that is about to newly enter the power feeding area A1, the control system 80 performs a determination process S1 of determining whether or not a first total electric power Nt1, which is the total amount of supply power for the existing transport vehicles V1 and the incoming transport vehicle V2, exceeds the upper power limit Nmax.

In response to determining that the first total electric power Nt1 exceeds the upper power limit Nmax, the control system 80 performs an entry restriction process S2 of restricting the incoming transport vehicle V2 from entering the power feeding area A1.

Examples of the entry restriction process S2 include causing the incoming transport vehicle V2 to stand by in an area on the upstream side from the power feeding area A1, changing the transport path K of the incoming transport vehicle V2 to a path that avoids the power feeding area A1, and the like. In the present embodiment, the host control device 81 transmits an instruction of the standby or the change of the transport path K to the first control device 11 or the second control device 21 of the incoming transport vehicle V2. Examples of the standby of the incoming transport vehicle V2 include causing the incoming transport vehicle V2 to stop, travel slowly, or travel in a loop in an area on the upstream side from the power feeding area A1.

In a case where the supply of electric power to the power feeding area A1 stops, the control system 80 permits only the second transport vehicle 20, out of the first transport vehicle 10 and the second transport vehicle 20 as the incoming transport vehicle V2, to enter the power feeding area A1. Examples of the case where the supply of electric power to the power feeding area A1 stops include a case where the power source unit 41 stops, a case where a feeder cable from the power source unit 41 to the power feeding member 42 breaks, and the like.

In the present embodiment, in a case where the supply of electric power to the power feeding area A1 stops, the control system 80 causes the second transport vehicle 20 as the incoming transport vehicle V2 to travel in the power feeding area A1 using electric power stored in the power storage device 45.

In the determination process S1, the control system 80 determines supply power for each of the existing transport vehicles V1 and the incoming transport vehicle V2, based on whether the each of the existing transport vehicle V1 and the incoming transport vehicle V2 is the first transport vehicle 10 or the second transport vehicle 20.

A second total electric power Nt2 is defined as the total amount of supply power for the existing transport vehicles V1. An expected supply power Nj is defined as supply power for the incoming transport vehicle V2. The first total electric power Nt1 is a value based on Expression (1).

first total electric power Nt1=second total electric power Nt2+expected supply power Nj+α1 . . . (1)
Note that α1 is a given constant.

A first expected supply power Nj1 (W) is defined as an expected supply power Nj when the incoming transport vehicle V2 is the first transport vehicle 10. A second expected supply power Nj2 (W) is defined as an expected supply power Nj when the incoming transport vehicle V2 is the second transport vehicle 20. The first total electric power Nt1 when the incoming transport vehicle V2 is the first transport vehicle 10 is a value based on Expression (2). The first total electric power Nt1 when the incoming transport vehicle V2 is the second transport vehicle 20 is a value based on Expression (3).

first total electric power Nt1=second total electric power Nt2+first expected supply power Nj1+α2 . . . (2)
Note that α2 is a given constant.

first total electric power Nt1=second total electric power Nt2+second expected supply power Nj2+α3 . . . (3)
Note that α3 is a given constant.

Examples of the first expected supply power Nj1 and the second expected supply power Nj2 include a value determined in advance by a supervisor, a setting value determined by the control system 80, and the like. The setting value determined by the control system 80 may be a predicted value derived by the control system 80 or may be a value determined based on a power value actually supplied to the transport vehicle.

A first supply power Nk1 (W) is defined as supply power for each first transport vehicle 10 included in the existing transport vehicles V1. A second supply power Nk2 (W) is defined as supply power for each second transport vehicle 20 included in the existing transport vehicles V1. N1 is defined as the number of first transport vehicles 10 included in the existing transport vehicles V1. N2 is defined as the number of second transport vehicles 20 included in the existing transport vehicles V1. The second total electric power Nt2 is a value based on Expression (4).

second total electric power Nt2=first power supply Nk1×N1+second power supply Nk2×N2+α4 . . . (4)
Note that α4 is a given constant.

Examples of a value determined as the first supply power Nk1 and a value determined as the second supply power Nk2 include a setting value input in advance by a supervisor, a setting value determined by the control system 80, a power value actually supplied to the transport vehicle, and the like. The setting value determined by the control system 80 may be a predicted value derived by the control system 80, or may be a value determined based on a power value actually supplied to the transport vehicle.

In the present embodiment, the control system 80 determines the supply power for the first transport vehicle 10 based on an average value of power consumption of the first transport vehicle 10 in the determination process S1. In the present embodiment, the first expected supply power Nj1 and the first supply power Nk1 are set to the same value. In the present embodiment, the second expected supply power Nj2 and the second supply power Nk2 are set to the same value.

The control system 80 determines the supply power for the second transport vehicle 20 based on electric power for use in at least one of charging and traveling, in the determination process S1. In the present embodiment, in the determination process S1, the control system 80 determines the supply power for the second transport vehicle 20 based on electric power for use in at least one of charging and traveling. In response to determining that the total electric power Nt exceeds the upper power limit Nmax in the determination process S1, the control system 80 causes the second transport vehicle 20 included in the existing transport vehicles V1 and the incoming transport vehicle V2 to travel using electric power stored in the power storage device 45, and performs the determination process S1 again with the supply power for the second transport vehicle 20 being determined to be zero.

In a case where charging is performed using electric power received by the second power reception device 24 in the power feeding area A1, the control system 80 sets the second expected supply power Nj2 to a value based on electric power for use in at least charging.

In a case where the second transport vehicle 20 is caused to travel using electric power received by the second power reception device 24 in the power feeding area A1, the control system 80 sets the second expected supply power Nj2 to a value based on electric power for use in at least traveling.

In a case where the control system 80 causes the second transport vehicle 20 to perform charging and traveling using electric power received by the second power reception device 24 in the power feeding area A1, the control system 80 sets the second expected supply power Nj2 to a value based on electric power for use in at least charging and traveling.

The control system 80 may be configured to cause the second transport vehicle 20 as the incoming transport vehicle V2 to use the electric power received by the second power reception device 24 for charging or traveling in accordance with the charging state of the power storage device 45.

The control system 80 determines the second supply power Nk2 based on electric power for use in charging and traveling for each second transport vehicle 20 included in the existing transport vehicles V1.

The control system 80 determines that the supply power for the second transport vehicle 20 is zero, in the determination process S1. In the present embodiment, in a case where the control system 80 causes the second transport vehicle 20 to travel using electric power stored in the power storage device 45, the control system 80 sets the second expected supply power Nj2 to zero.

In response to determining that the total electric power Nt exceeds the upper power limit Nmax in the determination process S1, the control system 80 causes the second transport vehicle 20 included in the existing transport vehicles V1 and the incoming transport vehicle V2 to travel using electric power stored in the power storage device 45 and performs the determination process S1 again with the supply power for the second transport vehicle 20 being determined to be zero.

In the present embodiment, in response to determining that the total electric power Nt exceeds the upper power limit Nmax in the determination process S1, the control system 80 causes the second transport vehicle 20 included in the existing transport vehicles V1 to travel using electric power stored in the power storage device 45 and performs the determination process S1 again with the second supply power Nk2 being determined to be zero.

In the present embodiment, in response to determining that the total electric power Nt exceeds the upper power limit Nmax in the determination process S1, the control system 80 causes the second transport vehicle 20 as the incoming transport vehicle V2 to travel using electric power stored in the power storage device 45 and performs the determination process S1 again with the second expected supply power Nj2 being determined to be zero.

In the present embodiment, the control system 80 derives a path cost required for the transport vehicle to travel from the transport source to the transport destination and determines a path with the lowest path cost as a transport path K for the transport vehicle.

In the present embodiment, the path cost is derived based on map information on the travel path R. For example, the map information includes information on a plurality of links and a plurality of nodes that represent the network structure of the travel path R. Each of the links includes information on a cost (passage cost) corresponding to its length, shape, and the like. Each of the nodes includes information on a path cost (passage cost) corresponding to the scale or the like of merges and branches, for example. The path cost is calculated as a total of the costs of all the links and nodes included in a path from the current position of the transport vehicle to the position of a candidate receiving conveyor,

The cost of each link and each node is most affected by a cost corresponding to the length of the link (the cost increases as the link length is longer). Accordingly, the path cost generally increases as the travel distance of the transport vehicle to the candidate receiving conveyor is longer. That is, the path cost generally decreases as the travel distance of the transport vehicle to the candidate receiving conveyor is shorter.

The path cost may be calculated based on other elements such as the number of points, on the path to the candidate receiving conveyor, at which the transport vehicle should stop temporarily and the likelihood of congestion, for example, in addition to the travel distance of the transport vehicle to the candidate receiving conveyor.

In the present embodiment, in a case where the difference between the upper power limit Nmax in the power feeding area A1 and the total amount (the second total electric power Nt2) of supply power for the existing transport vehicles V1 is smaller than the supply power for the first transport vehicle 10, the control system 80 determines the transport path K for each transport vehicle such that it becomes more difficult for the first transport vehicle 10 to pass through the power feeding area A1 than the second transport vehicle 20.

In the present embodiment, in a case where the difference between the upper power limit Nmax in the power feeding area A1 and the second total electric power Nt2 is smaller than the supply power for the first transport vehicle 10, the control system 80 determines the transport path K for the first transport vehicle 10 such that it becomes difficult for the first transport vehicle 10 to pass through the power feeding area A1. Examples of the setting to make it difficult for the first transport vehicle 10 to pass through the power feeding area A1 include increasing the cost of a node corresponding to the power feeding area A1, increasing the cost of a node adjacent to the power feeding area A1, increasing the cost of the power feeding area A1 per unit distance, and the like.

In the present embodiment, in a case where the difference between the upper power limit Nmax in the power feeding area A1 and the second total electric power Nt2 is smaller than the supply power for the first transport vehicle 10, the control system 80 determines the transport path K for the second transport vehicle 20 such that the second transport vehicle 20 easily passes through the power feeding area A1. Examples of the setting for the second transport vehicle 20 to easily pass through the power feeding area A1 include decreasing the cost of a node corresponding to the power feeding area A1, decreasing the cost of a node adjacent to the power feeding area A1, decreasing the cost of the power feeding area A1 per unit distance, and the like.

Next will be described other embodiments of the transport facility 100.
(1) The above embodiment has described, as an example, the configuration in which a plurality of power feeding areas A1 is provided on the travel path R. However, the embodiment of the transport facility 100 is not limited to such a configuration. For example, the travel path R may include only one power feeding area A1. For example, the power feeding members 42 may be provided throughout the travel path R, and the whole travel path R may be divided into a plurality of power feeding areas A1. For example, a plurality of power feeding areas A1 in which the power feeding members 42 are provided, and a plurality of non-power feeding areas in which no power feeding member 42 is provided may be provided in the travel path R.
(2) The above embodiment has described, as an example, the configuration in which, in a case where the control system 80 causes the second transport vehicle 20 to travel using electric power stored in the power storage device 45, the control system 80 determines that the supply power for the second transport vehicle 20 is zero, in the determination process S1. However, the embodiment of the transport facility 100 is not limited to such a configuration. For example, in a case where the control system 80 causes the second transport vehicle 20 to travel using electric power stored in the power storage device 45, the control system 80 may not determine that the supply power to the second transport vehicle 20 is zero, in the determination process S1.
(3) The above embodiment has described, as an example, the configuration in which, in a case where the control system 80 causes the second transport vehicle 20 to perform charging and traveling using electric power received by the second power reception device 24 in the power feeding area A1, the control system 80 sets the second expected supply power Nj2 to a value based on electric power for use in at least charging and traveling. However, the embodiment of the transport facility 100 is not limited to such a configuration. For example, the second transport vehicle 20 may be configured not to be chargeable in the power feeding area A1. For example, the second transport vehicle 20 may not include the second power reception device 24 configured to receive electric power from the power feeding member 42, and the second transport vehicle 20 may be configured to be charged only at a particular charging place. For example, the power storage device 45 of the second transport vehicle 20 may be replaced at a particular replacement place.
(4) The above embodiment has described, as an example, the configuration in which, in response to determining that the total electric power Nt exceeds the upper power limit Nmax in the determination process S1, the control system 80 causes the second transport vehicle 20 included in the existing transport vehicles V1 and the incoming transport vehicle V2 to travel using electric power stored in the power storage device 45 and performs the determination process S1 again with the supply power for the second transport vehicle 20 being determined to be zero. However, the embodiment of the transport facility 100 is not limited to such a configuration. For example, in response to determining that the total electric power Nt exceeds the upper power limit Nmax in the determination process S1, the control system 80 may cause only the second transport vehicle 20 included in either one of the existing transport vehicles V1 and the incoming transport vehicle V2 to travel using electric power stored in the power storage device 45.
(5) The above embodiment has described, as an example, the configuration in which, in a case where the supply of electric power to the power feeding area A1 stops, the control system 80 permits only the second transport vehicle 20, out of the first transport vehicle 10 and the second transport vehicle 20 as the incoming transport vehicle V2, to enter the power feeding area A1. However, the embodiment of the transport facility 100 is not limited to such a configuration. For example, in a case where the supply of electric power to the power feeding area A1 stops, the control system 80 may not permit the first transport vehicle 10 and the second transport vehicle 20 as the incoming transport vehicle V2 to enter the power feeding area A1.
(6) The above embodiment has described, as an example, the configuration in which the host control device 81 acquires information on the current position of the first transport vehicle 10 from the first transport vehicle 10 and acquires information on the current position of the second transport vehicle 20 from the second transport vehicle 20, and the number of second transport vehicles 20 is smaller than the number of first transport vehicles 10. However, the embodiment of the transport facility 100 is not limited to such a configuration. For example, the host control device 81 may acquire the current positions of the first transport vehicle 10 and the second transport vehicle 20 by detection information from a transport-vehicle detection device provided in the travel path R. For example, the number of second transport vehicles 20 may be larger than the number of first transport vehicles 10.
(7) Note that the configuration disclosed in the above embodiment can be applied in combination with the configurations disclosed in other embodiments as long as no inconsistency occurs. In terms of other configurations, the embodiment disclosed in the present specification is also just an example in all respects. Accordingly, various modifications can be made appropriately as far as it does not deviate from the scope of this disclosure.

The following describes the transport facility according to this disclosure.

As one aspect, a transport facility includes: a plurality of transport vehicles configured to travel along a travel path; a power feeding apparatus including a power feeding member provided along the travel path; and a control system configured to control the plurality of transport vehicles. The plurality of transport vehicles includes a first transport vehicle and a second transport vehicle. The first transport vehicle includes a first power reception device configured to receive electric power from the power feeding member to cause the first transport vehicle to travel using electric power received by the first power reception device. The second transport vehicle includes a power storage device and is configured to travel using electric power stored in the power storage device. The travel path provided with the power feeding member includes a power feeding area. The control system is configured as follows: in a case where there is an incoming transport vehicle that is about to newly enter the power feeding area, the control system performs a determination process of determining whether or not total electric power, which is a total amount of supply power for at least one existing transport vehicle already present in the power feeding area and supply power for the incoming transport vehicle, exceeds an upper power limit, which is an upper limit of supply power from the power feeding apparatus and is determined for the power feeding area; in response to determining that the total electric power exceeds the upper power limit, the control system performs an entry restriction process of restricting the incoming transport vehicle from entering the power feeding area; and in the determination process, the control system determines the supply power for the at least one existing transport vehicle based on whether the at least one existing transport vehicle is the first transport vehicle or the second transport vehicle, and determines the supply power for the incoming transport vehicle based on whether the incoming transport vehicle is the first transport vehicle or the second transport vehicle.

With this configuration, it is possible to prevent the supply power from the power feeding apparatus to the transport vehicles present in the power feeding area from exceeding the upper power limit. Accordingly, it is possible to appropriately supply electric power to all the transport vehicles present in the power feeding area and to reduce the possibility that a malfunction may occur due to an overload of the power feeding apparatus. In this case, the supply power for each of the incoming transport vehicle and the existing transport vehicle is determined based on whether the each of the incoming transport vehicle and the existing transport vehicle is the first transport vehicle or the second transport vehicle. Accordingly, supply power necessary for the second transport vehicle that travels using electric power stored in the power storage device can be determined to be smaller than the supply power for the first transport vehicle, for example. Accordingly, in comparison with a case where the entry restriction process is performed just based on the number of transport vehicles or the like, it is possible to reduce the frequency of performing the entry restriction process. This makes it possible to easily increase the number of transport vehicles that can pass through the power feeding area and eventually to easily increase the transport efficiency in the transport facility.

As one aspect, the control system may determine that the supply power for the second transport vehicle to is zero, in the determination process.

In this configuration, the second transport vehicle can travel using electric power stored in the power storage device. Accordingly, when it is determined that the supply power for the second transport vehicle in the power feeding area is a zero, it is possible to easily increase the number of transport vehicles that can pass through the power feeding area. This accordingly makes it possible to increase the transport efficiency in the transport facility.

As one aspect, the second transport vehicle may include a second power reception device configured to receive electric power from the power feeding member, and perform at least one of charging of the power storage device and traveling using electric power received by the second power reception device, and the control system may determine supply power for the second transport vehicle based on the electric power for use in the at least one of charging and traveling, in the determination process.

With this configuration, in the power feeding area, the second transport vehicle can travel using electric power stored in the power storage device, and the second transport vehicle can also perform at least one of charging the power storage device and traveling using electric power received by the second power reception device. Accordingly, in comparison with a configuration in which the second transport vehicle is charged only at a particular charging place, it is possible to reduce the necessity to stop the second transport vehicle for charging, thereby making it possible to increase the operating ratio of the second transport vehicle. This accordingly makes it possible to increase the transport efficiency in the transport facility. With the configuration of the second transport vehicle, it is possible to appropriately determine the supply power for the second transport vehicle in the power feeding area.

As one aspect, in response to determining that the total electric power exceeds the upper power limit in the determination process, the control system may cause the second transport vehicle included in the at least one existing transport vehicle and the incoming transport vehicle to travel using electric power stored in the power storage device, and perform the determination process again with the supply power for the second transport vehicle being determined to be zero.

With this configuration, even in a case where the total amount of supply power for the power feeding area is determined to exceed the upper power limit in the determination process performed with the second transport vehicle being able to use electric power for at least one of charging and traveling, for example, when the second transport vehicle is caused to travel using electric power stored in the power storage device, the supply power for the second transport vehicle becomes zero, thereby making it possible to increase the margin to the upper power limit. Hereby, it is possible to increase the number of transport vehicles that can pass through the power feeding area, thereby making it possible to increase the transport efficiency in the transport facility.

As one aspect, in a case where supply of electric power to the power feeding area stops, the control system may permit only the second transport vehicle, out of the first transport vehicle and the second transport vehicle as the incoming transport vehicle, to enter the power feeding area.

With this configuration, even in a case where the supply of electric power to the power feeding area stops, the second transport vehicle can pass through the power feeding area. Accordingly, in comparison with a case where passage through the power feeding area is completely prohibited due to stop of the supply of electric power to the power feeding area, it is possible to increase the number of transport vehicles that can pass through the power feeding area and eventually to increase the transport efficiency in the transport facility.

As one aspect, in a case where a difference between the upper power limit in the power feeding area and a total amount of the supply power for the at least one existing transport vehicle is smaller than supply power for the first transport vehicle, the control system may determine a transport path for each of the plurality of transport vehicles such that it becomes more difficult for the first transport vehicle to pass through the power feeding area than the second transport vehicle.

With this configuration, it is possible to easily suppress occurrences of stops and congestion of the transport vehicles due to restriction of entry of the first transport vehicle into the power feeding area to prevent the total amount of supply power for the at least one existing transport vehicle from exceeding the upper power limit of the power feeding apparatus. This accordingly makes it possible to increase the transport efficiency in the transport facility.

The transport facility according to this disclosure should be able to achieve at least one of the above effects. The technical feature of the transport facility according to this disclosure is also applicable to a transport method and a transport program.

What is claimed is:

1. A transport facility, comprising:
a plurality of transport vehicles configured to travel along a travel path;
a power feeding apparatus comprising a power feeding member provided along the travel path; and
a control system configured to control the plurality of transport vehicles, and
the plurality of transport vehicles comprising a first transport vehicle and a second transport vehicle,
the first transport vehicle comprising a first power reception device configured to receive electric power from the power feeding member to cause the first transport vehicle to travel using electric power received by the first power reception device,
the second transport vehicle comprising a power storage device and configured to travel using electric power stored in the power storage device,
the travel path, provided with the power feeding member, comprising a power feeding area, and
wherein the control system is configured as follows:
in a case where there is an incoming transport vehicle that is about to newly enter the power feeding area, the control system performs a determination process of determining whether or not total electric power, which is a total amount of supply power for at least one existing transport vehicle already present in the power feeding area and supply power for the incoming transport vehicle, exceeds an upper power limit, which is an upper limit of supply power from the power feeding apparatus and is determined for the power feeding area,
in response to determining that the total electric power exceeds the upper power limit, the control system performs an entry restriction process of restricting the incoming transport vehicle from entering the power feeding area, and
in the determination process, the control system determines the supply power for the at least one existing transport vehicle based on whether the at least one existing transport vehicle is the first transport vehicle or the second transport vehicle, and determines the supply power for the incoming transport vehicle based on whether the incoming transport vehicle is the first transport vehicle or the second transport vehicle.

2. The transport facility according to claim 1, wherein:
the control system determines that the supply power for the second transport vehicle to is zero, in the determination process.

3. The transport facility according to claim 1, wherein:
the second transport vehicle comprises a second power reception device configured to receive electric power from the power feeding member, and performs at least one of charging of the power storage device and traveling using electric power received by the second power reception device, and
the control system determines supply power for the second transport vehicle based on the electric power for use in the at least one of charging and traveling, in the determination process.

4. The transport facility according to claim 3, wherein:
in response to determining that the total electric power exceeds the upper power limit in the determination process, the control system causes the second transport vehicle included in the at least one existing transport vehicle and the incoming transport vehicle to travel using electric power stored in the power storage device and performs the determination process again with the supply power for the second transport vehicle being determined to be zero.

5. The transport facility according to claim 1, wherein:
in a case where supply of electric power to the power feeding area stops, the control system permits only the second transport vehicle, out of the first transport vehicle and the second transport vehicle as the incoming transport vehicle, to enter the power feeding area.

6. The transport facility according to claim 1, wherein:
in a case where a difference between the upper power limit in the power feeding area and a total amount of the supply power for the at least one existing transport vehicle is smaller than supply power for the first transport vehicle, the control system determines a transport path for each of the plurality of transport vehicles such that it becomes more difficult for the first transport vehicle to pass through the power feeding area than the second transport vehicle.
